(19) United States
(12) Patent Application Publication
(10) Pub. No.: US 2005/0099636 A1
(43) Pub. Date: May 12, 2005

(54) Telecentric optical sensor

(76) Inventor: Albert Schweser, Tettnang-Kau (DE)

Correspondence Address: KENNEDY COVINGTON LOBDELL & HICKMAN, LLP, 214 N. TRYON STREET, HEARST TOWER, 47TH FLOOR, CHARLOTTE, NC, 28202, US

(21) Appl. No.: 10/980,965

(22) Filed: Nov. 4, 2004

Related U.S. Application Data
(60) Provisional application No. 60/518,101, filed on Nov. 7, 2003.

(51) Int. Cl. G01B 11/24

(52) U.S. Cl. 356/601

(57) ABSTRACT

A system and methods for analyzing one or more extrusion samples in a horizontal arrangement. The system includes a telecentric lens, a fixture assembly for supporting an extrusion sample in a horizontal orientation relative to the lens, and a camera for capturing images of the cross-section of the sample. The fixture assembly includes one or more recesses for cradling the samples in front of the lens. The size of the recesses may be adjusted to accommodate different samples. A digital image of the samples in the fixture assembly is generated using the camera and may be analyzed using conventional software. The entire system is supported by a cabinet with one or more enclosures for the various components.

### CROSS-REFERENCE TO RELATED APPLICATION

This application is entitled to the benefit of, and claims priority to provisional U.S. Patent Application Ser. No. 60/518,101 filed Nov. 7, 2003 and entitled “TELECENTRIC OPTICAL SENSOR,” the entirety of which is incorporated herein by reference.

### BACKGROUND OF THE PRESENT INVENTION

1. Field of the Present Invention

The present invention relates generally to technologies for optical measurement of product samples, and, in particular, to the use of telecentric lenses for capturing optical cross-sectional images of extruded materials for further dimensional analysis.

2. Background

Optical technology for measuring samples of extruded material is very well known. Typically, optical information about a particular sample is captured by a lens system and focused on a small semiconductor image sensor called a charge-coupled device (“CCD”). Special software may then be utilized to analyze the data stored in the CCD to determine the dimensions of the sample.

Historically, the lens systems utilized in such optical measurement technology have been conventional in nature. FIG. 1 is a schematic illustration of such a system, which includes a scanner comprising a sheet of clear glass and one or more lenses for capturing light and projecting it onto the CCD. The object to be measured is placed directly on the glass, with the end of the object to be measured oriented to face downward, toward the lens system. In this type of arrangement, the beam paths between the CCD-line and the measured object are not parallel. This is illustrated in FIG. 1. As a result, if the object is not deburred sufficiently, then rough portions (“burrs”) may remain on the sample, thereby creating distortions in the image. On the other hand, if the sample is deburred too much (thereby creating overly-rounded corners or the like), if the measured surface is not cut or formed at exactly 90 degrees (right-angled) to the main axis of the sample, or if the surface of the end of the sample is not perfectly flat, then shadows are created at the plate of glass, resulting in measurement errors.

Thus, in order to get good measurement results, samples must be burr-free but not excessively deburred, sharp-edged, right-angled (exactly 90 degrees), and flat. If the sample does not fulfill those requirements, then additional measurement deviations (errors) are created.

Some of these problems have been eliminated through the introduction of small telecentric lenses in the place of the conventional lenses. As is well known, telecentric lenses operate with a parallel beam path. This may be only a slight difference from conventional camera lenses, but the use of such lenses has had a significant effect on the non-contact measurement, inspection and identification of objects by means of CCD cameras. Because the image parameters in the telecentric range always remain constant, even with varying object distances, depth dimensions now have no more than a negligible effect on measurements. This is illustrated in FIGS. 2A and 2B. In FIG. 2A, the distance between the lens and the respective objects affects the image, whereas in FIG. 2B the same image is produced no matter how far apart the two objects are, or theoretically, how far they are from the lens (assuming they are within the telecentric range of the lens).

Because of the parallel ray path utilized by telecentric measurement, no shadows are created, and thus it is no longer critical for the samples to be flat and sharp-edged. A typical optical measurement application using a telecentric lens is illustrated in FIG. 3. Unfortunately, in order to get good results, even when using a telecentric lens, samples must still be burr-free and right-angled (exactly 90 degrees). If the sample does not fulfill those requirements, then additional measurement deviations (errors) are likely to occur. More unfortunately, one of the most difficult things in sample preparation is making a very exact right-angled cut. In fact, because making such highly accurate cuts is prohibitively expensive and difficult, most manufacturers choose instead to sacrifice accuracy in favor of cost and speed. Thus, an accurate optical technology is still needed that can measure extruded material samples without requiring the samples to be cut at precisely a right-angle.

Another problem with all known telecentric-based optical measurement systems is their inherent difficulty in handling extruded materials of larger cross-sections. Traditional systems are typically limited to capturing only partial images of the extrusion sample. An image of a larger extrusion sample can be created by capturing multiple partial images of the sample, shifting the lens and camera slightly from partial image to partial image and then utilizing software to combine the multiple partial images into a single composite image. Such a methodology is tedious and inefficient and also introduces additional inaccuracies into the process. A method and apparatus for avoiding this issue for large extruded materials is needed.

### SUMMARY OF THE PRESENT INVENTION

The present invention comprises an optical measurement system utilizing a camera, a large telecentric lens, a light source, one or more glass plates, and a fixture to gather images of a sample from the side of a sample, rather than from the top or the bottom of the sample. In this way, if the fixture is aligned with the beam path of the lens, then if a sample part is placed into the fixture, it is automatically aligned such that its extrusion axis is positioned at exactly a 90 degree angle to the face of the lens. As shown in FIG. 4, the end of the sample need not be cut at a right angle in order to ensure measurement accuracy. As a result, it is much easier and faster to prepare samples for testing and measurement, because it is no longer necessary to cut the samples at precisely 90 degrees. In addition, the risk of excessive deburring is much lower, because the rounded corners created thereby have much less of an impact on the measurement of the sample. Also, the lens and camera are preferably of very high resolution to permit images of larger extruded materials to be captured without requiring the use of complicated composite image processing.

Broadly defined, the present invention according to one aspect is a method of analyzing an extrusion sample, including: arranging the sample in a generally horizontal orientation in the object field of a telecentric lens; capturing, via a camera positioned to receive images from the image field of the telecentric lens, an image of the cross-section of the sample via the telecentric lens; and analyzing the sample image.

In features of this aspect, the extrusion sample defines an extrusion axis and the telecentric lens defines a central axis, and arranging the sample includes positioning the sample such that its extrusion axis is parallel to the central axis; arranging the sample includes supporting the side of the sample, from below; arranging the sample includes arranging a plurality of samples in a generally horizontal orientation in the object field of a telecentric lens; and capturing an image includes capturing an image that includes all of the cross-sections of all of the plurality of samples; capturing includes capturing a digital image via a digital camera; capturing includes capturing a digital image via a linear scan camera; the method further includes converting the image captured via the camera to a digital image; analyzing includes analyzing, via software, the sample image; the method further includes separating the extrusion sample from the telecentric lens by a transparent partition assembly; and arranging includes arranging the extrusion sample such that when the sample image is captured, the sample is spaced apart from the transparent partition assembly in a non-contact arrangement.

In another aspect, the present invention is a system for analyzing an extrusion sample, including: a telecentric lens; a fixture assembly for supporting an extrusion sample in a generally horizontal orientation in the image field of the telecentric lens; and a camera for capturing images of the cross-section of the sample via the telecentric lens while the sample is supported in the fixture assembly.

In features of this aspect, the camera is a digital camera; the camera is a linear scan camera; the system further includes a light source; the light source is a reflective light source for casting light on the extrusion sample that is reflected from the sample to the telecentric lens; the fixture assembly is dark-colored to increase optical contrast between the extrusion sample and the fixture assembly; the light source is a background light source arranged in the background on the opposite end of the extrusion sample from the telecentric lens to increase optical contrast between the extrusion sample and the background; the system further includes a cabinet that substantially encloses the fixture assembly and the telecentric lens; the cabinet further substantially encloses the camera; and the cabinet includes a first compartment, and wherein the fixture assembly is disposed in the first compartment.

In yet another aspect, the present invention is a method of analyzing an extrusion sample, including: providing an optical lens, defining a central axis; arranging a fixture assembly, having at least one support that defines a recess for supporting at least a portion of the extrusion sample in alignment with the central axis of the lens, in front of the lens; positioning the extrusion sample in the recess; and capturing an image of the cross-section of the sample while the extrusion sample is positioned in the recess.

In features of this aspect, capturing includes capturing a digital image of the cross-section of the sample; arranging a fixture assembly includes arranging a fixture assembly having at least one support that includes at least a pair of support structures that together define the recess, and the method further includes adjusting the position of at least one of the support structures to change the size of the recess; arranging a fixture assembly includes arranging a fixture assembly having at least two supports in front of the lens, and the method further includes moving at least one of the supports in a direction generally parallel to the central axis to adjust the distance between the at least two supports; positioning the sample in the recess includes positioning a plurality of samples in the recess, and capturing an image includes capturing an image that includes all of the cross-sections of all of the plurality of samples; and positioning the sample in the recess includes cradling the sample in the recess.

In still another aspect, the present invention is a system for analyzing an extrusion sample, including: a lens; a fixture assembly for supporting an extrusion sample in the image field of the lens, the fixture assembly including at least two fixture supports for supporting opposite ends of the extrusion sample; and a digital camera for capturing digital images of the cross-section of the sample via the lens.

In features of this aspect, the lens defines a central axis, and the fixture assembly supports the extrusion sample in generally parallel alignment with the central axis of the lens; at least one of the fixture supports is a unitary support structure that defines a recess whose size and shape are arranged to position the extrusion sample in the image field of the lens; the image field of the lens is circular, the at least one of the fixture supports is a fixture plate, and the recess is generally semicircular; the system further includes an adapter; defining a recess of a size different than that of the recess in the unitary support structure, that may mounted to the fixture support by a user; at least one of the fixture supports includes first and second support structures that are adjustable relative to each other, the first and second support structures jointly define a recess, and the size of the recess may be changed by adjusting the disposition of the first support structure relative to the second support structure, thereby positioning the extrusion sample in the image field of the lens; and the first and second support structures are fixture plates that jointly define a V-shaped recess, and the size of the “V” may be changed by adjusting the disposition of the first support structure relative to the second support structure.

In other features of this aspect, the at least one fixture support is a first fixture support, at least a second of the fixture supports includes third and fourth support structures that are adjustable relative to each other, the third and fourth support structures jointly define a recess, the size of the recess may be changed by adjusting the disposition of the third support structure relative to the fourth support structure, thereby positioning the extrusion sample in the image field of the lens, and the fixture assembly further includes a linkage for controlling movement of the third support structure relative to the fourth support structure in conjunction with the control of movement of the first support structure relative to the second support structure; the fixture assembly further includes a user control device, connected to the linkage, that is adapted to provide simultaneous control of the adjustment of both the first and second support structures and the third and fourth support structures; and at least one of the fixture supports may be moved in a direction generally parallel to the central axis to adjust the distance between the at least two fixture supports.

In still another aspect, the present invention is a system for analyzing an extrusion sample, including: a cabinet having at least a first compartment and a second compartment arranged in a generally horizontal row; an optical lens disposed at least partially in the first compartment; and a camera disposed in the cabinet and arranged to receive images of an object placed in the second compartment via the optical lens.

In features of this aspect, the cabinet further includes at least a third compartment, the third compartment is arranged in the generally horizontal row such that the first compartment is interposed between the second and third compartments, and the camera is disposed in the third compartment; the second compartment is defined by an enclosure; the enclosure defining the second compartment includes a door for accessing the compartment; the door is a roll top door; at least one transparent partition is interposed between the first and second compartments; the at least one transparent partition includes two glass partitions, one of which is arranged to be easily replaceable by an operator; a fixture assembly is disposed within the second compartment for supporting the object placed therein; the fixture assembly is adjustable to permit the object placed therein to be moved into the field of view of the optical lens; the second compartment includes at least one wall disposed in the field of view of the optical lens such that when placed therein, the object is interposed between the at least one wall and the optical lens; the at least one wall is dark in color to improve contrast between the at least one wall and the object; the at least one wall includes an illumination source that backlights the object; the system further includes a light source arranged to cast light on the extrusion sample that is reflected from the sample to the optical lens; and the system further includes a video monitor interfaced with the camera and carried by the cabinet.

In still another aspect, the present invention is a method of analyzing an extrusion sample, including: providing a cabinet having at least a first compartment and a second compartment arranged in a generally horizontal row; positioning an optical lens at least partially in the first compartment; positioning a camera adjacent the optical lens; arranging the camera to receive images of objects that are placed in the second compartment via the optical lens; placing an extrusion sample in the second compartment; and capturing, in the camera, an image of the extrusion sample.

In features of this aspect, providing a cabinet includes providing a cabinet having at least a third compartments arranged in the generally horizontal row such that the first compartment is interposed between the second and third compartments, and positioning the camera includes positioning the camera in the third compartment; the second compartment includes a door that is adjustable at least between a closed position and an open position, and the method further includes adjusting the door to the open position before placing the extrusion sample in the second compartment; and the extrusion sample defines an extrusion axis, and placing the extrusion sample in the second compartment includes aligning the extrusion axis of the extrusion sample horizontally with the optical lens.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Further features, embodiments, and advantages of the present invention will become apparent from the following detailed description with reference to the drawings, wherein:

FIG. 1 is a schematic illustration of a prior art optical measurement system;

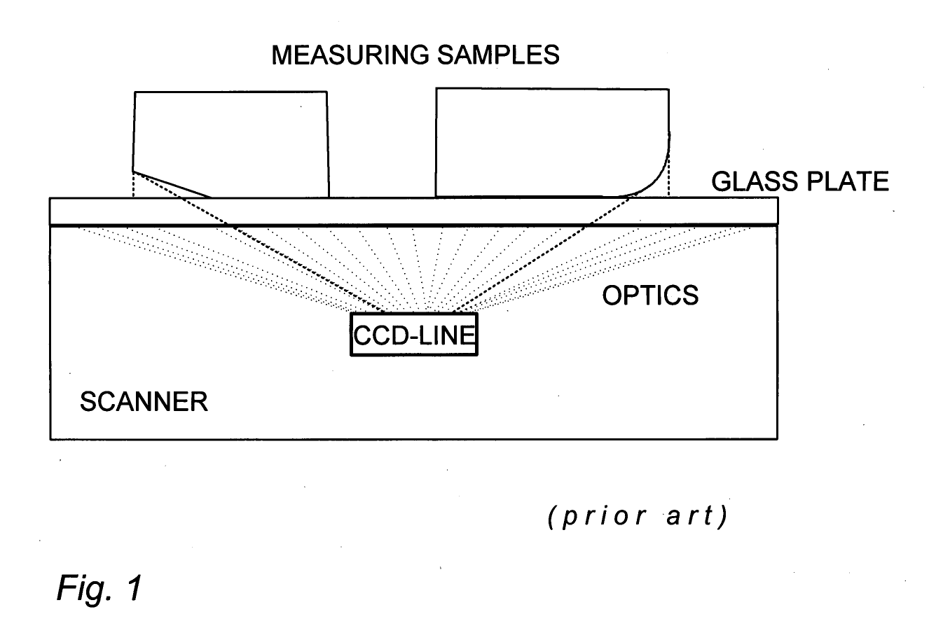

FIGS. 2A and 2B are schematic diagrams comparing the operation of a telecentric lens with a conventional lens;

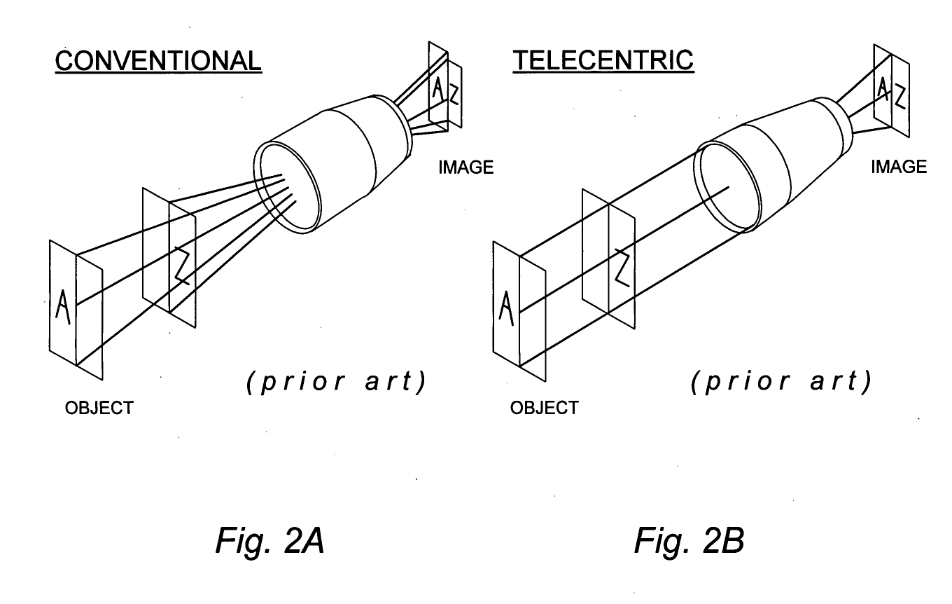

FIG. 3 is a schematic diagram illustrating a typical optical measurement application using a telecentric lens;

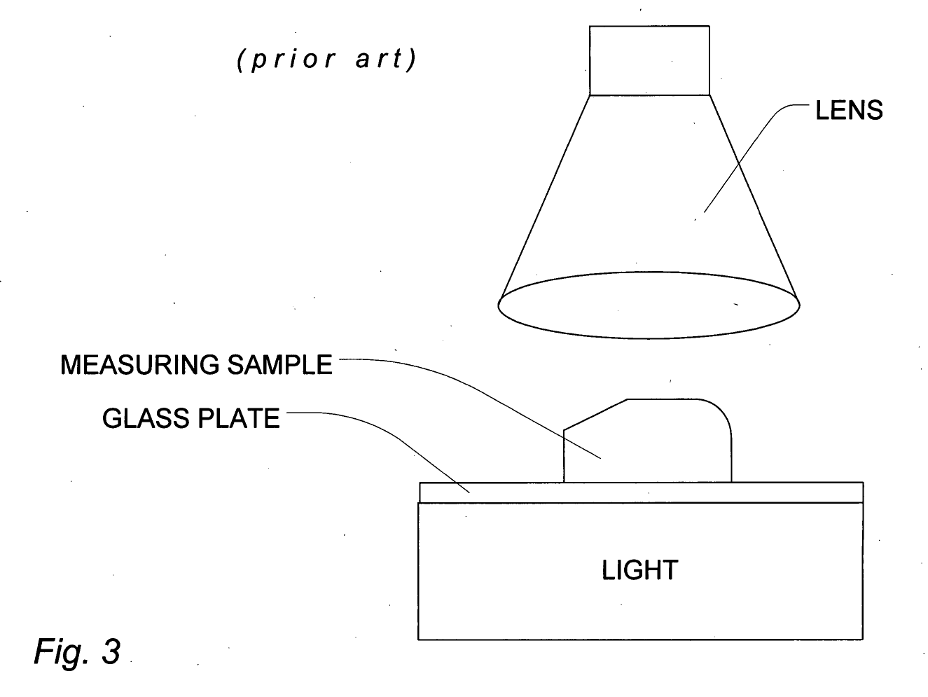

FIG. 4 is a side schematic diagram illustrating the operation of the present invention;

FIG. 5 is a front view of an optical measurement system in accordance with a first preferred embodiment of the present invention;

FIG. 6 is a top cross-sectional view of the system of FIG. 5, taken along line 6-6;

FIG. 7 is a partial front cross-sectional view of the system of FIG. 6, taken along line 7-7;

FIG. 8 is a partial left side cross-sectional view of the system of FIG. 6, taken along line 8-8;

FIG. 9 is a partial left side cross-sectional view of the system of FIG. 6, taken along line 8-8, illustrating an alternative fixture assembly arrangement;

FIG. 10 is a front view of an optical measurement system in accordance with a second preferred embodiment of the present invention;

FIG. 11 is a top cross-sectional view of the system of FIG. 10, taken along line 11-11;

FIG. 12 is a partial front cross-sectional view of the system of FIG. 11, taken along line 12-12;

FIG. 13 is a partial left side cross-sectional view of the system of FIG. 11, taken along line 13-13; and

FIG. 14 is a partial left side cross-sectional view similar to that of FIG. 13, but illustrating the placement of a sample therein.

### DETAILED DESCRIPTION OF THE PREFERRED EMBODIMENTS

Referring now to the drawings, in which like numerals represent like components throughout the several views, the preferred embodiments of the present invention are next described. The following description of the preferred embodiment(s) is merely exemplary in nature and is in no way intended to limit the invention, its application, or uses.

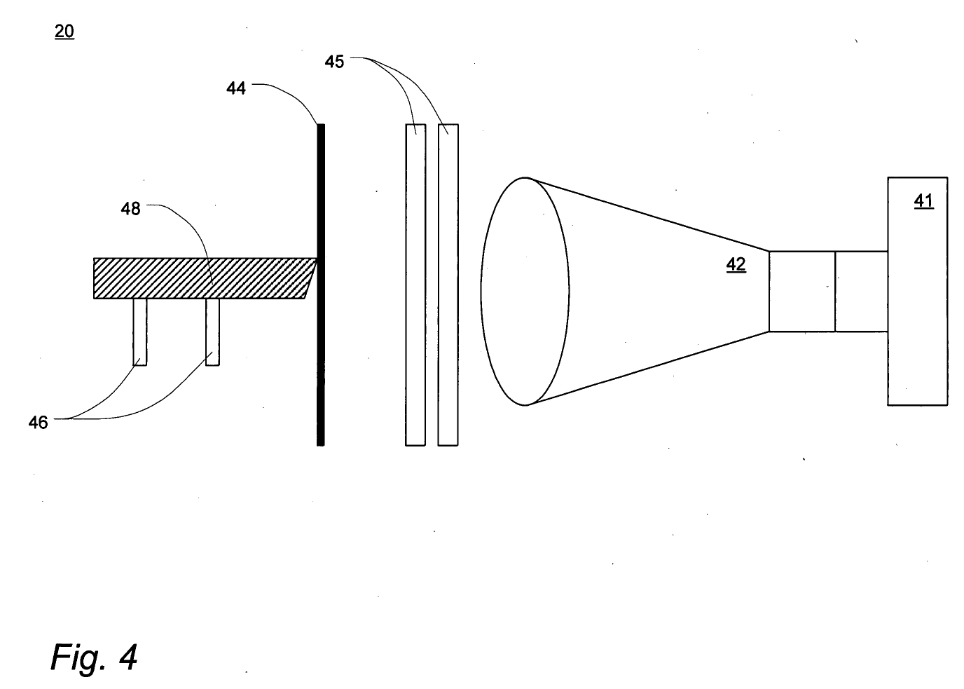

FIG. 4 is a side schematic diagram illustrating the operation of the present invention. A system 20 includes a camera 41, a large telecentric lens 42, a light source 45, one or more glass plates 44 and a fixture assembly 46. The camera 41 gathers images of one or more samples 48, placed in or on the fixture assembly 46, from the side, rather than from the top or the bottom.

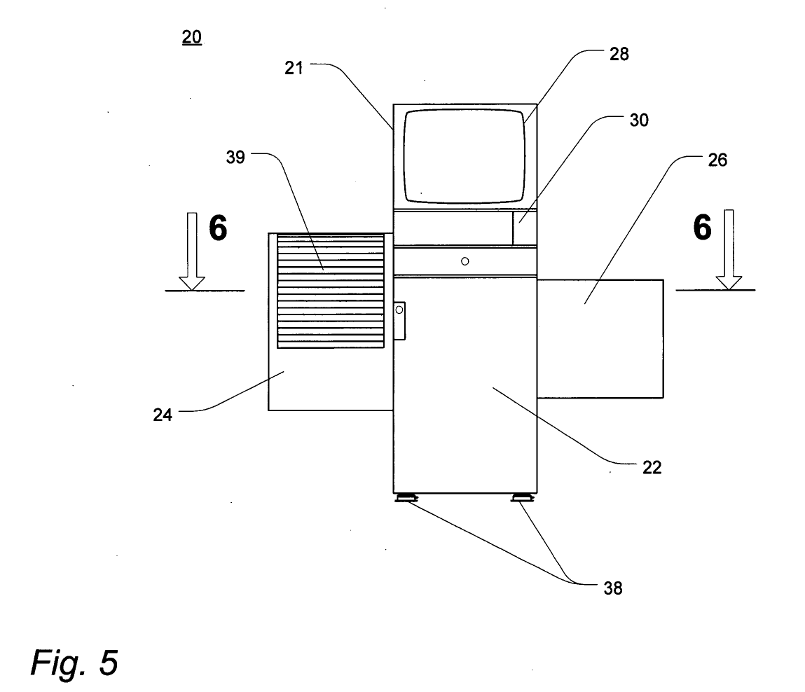

FIG. 5 is a front view of an optical measurement system 20 in accordance with a first preferred embodiment of the present invention. The system 20 includes a cabinet 21 in which are housed a video monitor 28, a control panel 30 and a number of internal components. The cabinet 21 is preferably mounted on leveling feet 38 in order to ensure more precise operation by minimizing vibration, and includes one or more compartments 22, 24, 26. Alternatively, however, the leveling feet 38 may be replaced or supplemented by wheels (not shown) for portability. The design and selection of devices such as leveling feet and wheels would be apparent to one of ordinary skill in the art. In the embodiments shown, the compartments include a first compartment 22, referred to hereinafter as the main compartment; a second compartment 24, referred to hereinafter as the operational compartment; and a third compartment 26, referred to hereinafter as the camera compartment. However, it should be apparent that the number, size, shape and orientation of the compartments may be varied as desired for reasons of compactness, usability, ability to accommodate the internal components, and the like.

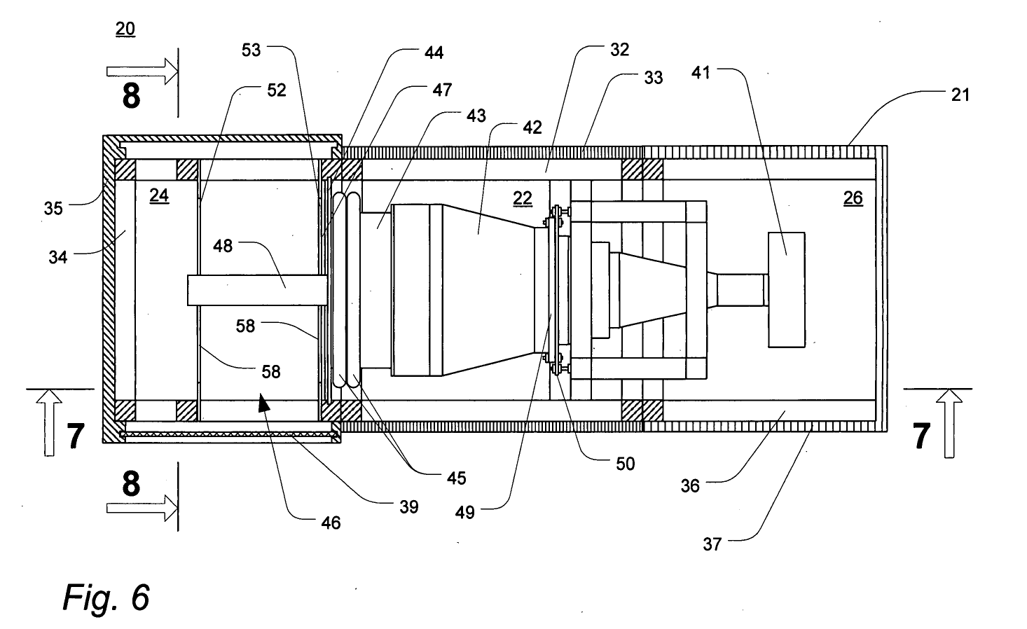

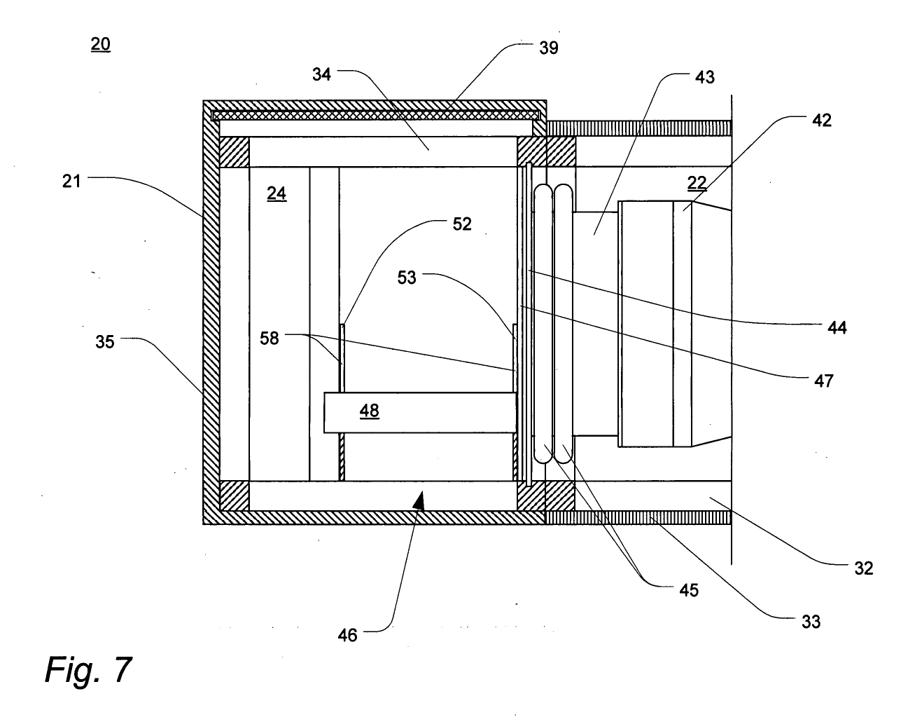

FIG. 6 is a top cross-sectional view of the system 20 of FIG. 5, taken along line 6-6, and FIG. 7 is a partial front cross-sectional view of the system 20 of FIG. 6, taken along line 7-7. As perhaps best shown in FIG. 6, each compartment 22, 24, 26 includes a respective frame 32, 34, 36 and a respective enclosure 33, 35, 37, taking the form of one or more panels, doors and the like, that collectively create a respective enclosed space. The internal operational components are arranged in the various compartments 22, 24, 26. In order to minimize exposure to the outside environment, the panels and doors preferably form solid barriers, but internal openings between the respective compartments 22, 24, 26 may be necessary as made evident hereinbelow. Because the interiors of the main compartment 22 and the camera compartment 26 are generally accessed only relatively infrequently, these compartments 22, 26 are preferably provided with swinging doors that latch in place when closed. On the other hand, because the operational compartment 24 must be entered frequently during use of the system 20, a track-mounted “roll top” type door 39, best seen in FIG. 5, may preferably be provided for this compartment 24. Such a door 39 may be retracted out of the way of the user so that he may have unobstructed access to the interior of the operational compartment 24 for purposes described hereinbelow. The height to which the door 39 is raised may also be adjusted in order to provide the necessary amount of access to the interior of the compartment 24 without exposing the interior unnecessarily to the outside environment. Cabinets, frames and frame members, enclosures and the like, suitable for use with the present invention, are available from Rittal GmbH & Co. of Herborn, Germany.

Referring again to FIGS. 6 and 7, the internal components of the system 20 include the camera 41, the telecentric lens 42, a diffusor 43, a pair of glass plates 44, 47, the light source 45 and the fixture assembly 46 for supporting one or more sample parts 48. The first glass plate 44 serves as the “operational” glass plate and is precisely calibrated for use in the system 20, while the second glass plate 47 is a protective plate used to prevent the operational plate 44 from being scratched or otherwise damaged. When the protective plate 47 is damaged, it may be removed and replaced without replacing the operational plate 44, thus avoiding the necessity of recalibrating the system 20.

The telecentric lens 42 may be a visible light optical lens that is housed or mounted laterally in the main compartment 22 and aimed toward the operational compartment 24 such that its viewing end is disposed in the camera compartment 26. Openings may be provided between the main compartment 22 and the operational compartment 24 in order to facilitate the placement of the lens 42. Typically, such a lens 42 includes a circumferential flange 49 to permit the lens 42 to be fastened to a mounting plate 50 supported by the cabinet 21. The object field of the lens 42 is preferably as large as possible in order to provide a maximum imaging area, but smaller lenses may likewise be used for smaller sample sizes. The image field of the lens 42 may be selected to match the requirements of the camera 41. One lens suitable for use in the preferred embodiments of the present invention is the VISIONMES 150/11/0.1 lens available from Carl Zeiss, Inc. of Thornwood, N.Y., which has a object field of 150 mm and an image field of 11 mm.

As shown in FIG. 6, the camera 41, which may be a visible light digital camera, is housed in the camera compartment 26 and arranged at the viewing end of the telecentric lens 42. The camera 41 is preferably selected to have a charge couple device (“CCD”) that corresponds in size to the image field of the telecentric lens 42. The camera 42 preferably also provides extremely high resolution, a wide color range and a communications interface suitable for connecting to a processing computer. Because of the very large size of the telecentric lens 42, the resolution of the camera 41 may be of particular significance, since the increased amount of visual data present in the object field of the lens 42 (due to its larger size than lenses traditionally used in optical measurement systems) would be wasted if a camera with sufficient resolution is not utilized in conjunction therewith. One camera suitable for use in the preferred embodiments of the present invention is the PRAKITCA Scan 3000M camera available from Pentacon GmbH of Dresden, Germany with a 42.9×42.9 mm CCD.

As noted previously, the number, size, shape and orientation of the compartments may be varied as desired for reasons of compactness, usability, ability to accommodate the internal components, and the like. For example, it will be apparent that the camera compartment 26 may be consolidated with the main compartment 22 if the lens 42, camera 41 and other components are small enough to fit in a single compartment (not shown), or if the main compartment 22 is enlarged to accommodate the components. Because one primary factor in the horizontal size of the cabinet 20 is the size of the telecentric lens 42 (which may vary widely depending on the size of the object field of thereof), a two-compartment cabinet 20 may be particularly useful if a relatively small lens 42 is to be used. Functionally, the two- and three-compartment versions may be generally similar in that a partition may or may not exist between the portion of the cabinet 20 housing the camera 41 and the portion housing the main portion of the lens 42. However, for larger sizes of telecentric lens 42, the additional compartment 26 may be preferred for ease of construction or less wasted cabinet space. Thus, the cabinet 20 will be described hereinafter as having three compartments 22, 24, 26; however, it will be apparent that the teachings of the present invention apply equally to two-compartment versions as well.

In the embodiments illustrated herein, the light source 45 is a reflective light source disposed at the face (object end) of the lens 42 and arranged to illuminate objects placed in the operational compartment 24 in the field of view of the lens 42. Preferably, the light generated by the light source 45 casts light as evenly as possible on objects placed in the operational compartment 24, and particularly on samples 48 supported in the fixture assembly 46. One light source suitable for use with the preferred embodiments of the present invention includes a pair of circular light bulbs disposed beyond the end of, and coaxial with, the lens 42. One such bulb is the OSRAM L40W/21-840C, with a ballast such as the EVG ELS 111 (230V/50 Hz or 110V/60 Hz), available from Eckert. Uniform light distribution may be further enhanced through the inclusion of a diffusor 43, formed from diffuse paper or the like, placed between the light source 45 and the object of interest, preferably close to the light source 45. For example, if circular light bulbs are used, the diffusor 43 may be a translucent cylinder arranged coaxially with, and radially inwardly from, the light bulbs 45.

In the embodiments illustrated herein, the lens 42, light source 45 and diffusor 43 are all arranged, and the compartments 22, 24, 26 configured, such that the diffusor 43 and light source 45 are disposed between the face of the lens 42 and the side of the main compartment 22, or even extending slightly into the wall of the adjacent operational compartment 24. In order to protect the lens 42 and the other optical components from dirt, dust, bumps and other potentially damaging elements, the wall of the operational compartment 24 preferably incorporates the second transparent glass plate 44, interposed between the diffusor 43 and the interior of the operational compartment 24.

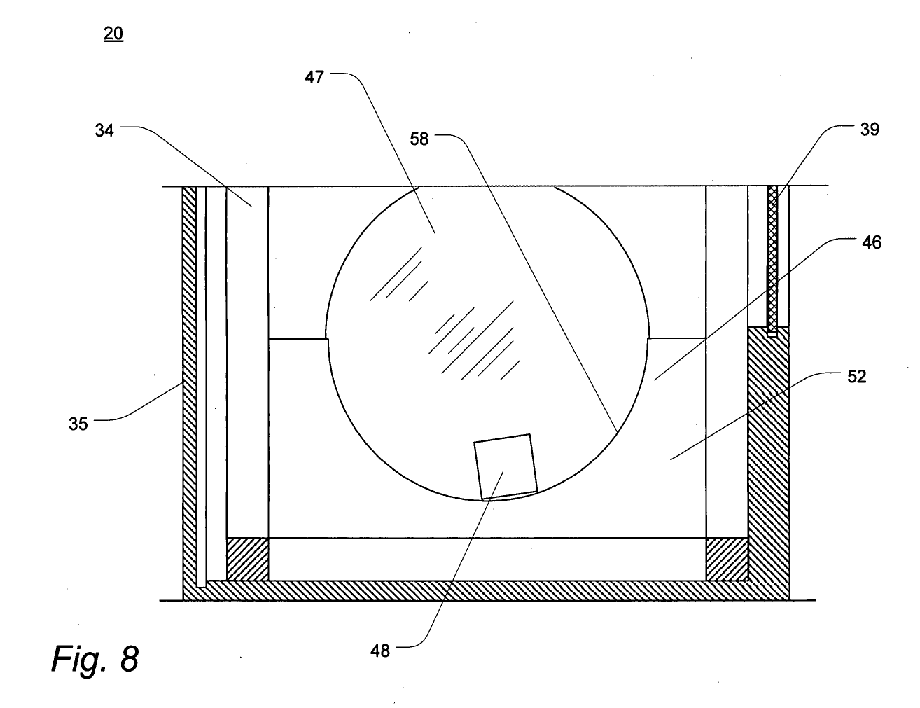

FIG. 8 is a partial left side cross-sectional view of the system 20 of FIG. 6, taken along line 8-8. As collectively illustrated in FIGS. 6-8, the fixture assembly 46 includes a pair of supports 52, 53, which in the preferred embodiments are solid fixture plates, each generally rectangular in shape but with a semicircular recess 58 extending downward from its upper edge. In one arrangement, the radius of each recess 58 may be chosen to be the same as, or slightly smaller than, the radius of the effective viewing area of the telecentric lens 42, and the two plates 52, 53 are arranged such that the centers of the respective semicircles 58 are coaxial with the main axis of the lens 42, as perhaps best seen in FIG. 8. The plates 52, 53 are connected to, and supported by, the walls or framework 34 of the operational compartment 24. The connection may be fixed, such that the positions of the plates 52, 53 remain constant relative to each other and to the lens 42, or the fixture assembly 46 may further include components for facilitating the adjustment of the position of all or part of the fixture assembly 46, such as described hereinbelow.

To use the system 20, the access door 39 of the operational compartment 24 is first opened, thus providing the user with access to the fixture assembly 46. One or more sample parts 48 may be placed in the semicircular recesses 58 in the fixture plates 52, 53 and arranged such that they lie in parallel with the center axis or beam path of the lens 42. The curvature and alignment of the fixture plates 52, 53 aids in this process because each sample part 48 has a natural tendency to settle into the same position in each fixture plate 52, 53, and the fixture plates 52, 53 are each arranged to be perpendicular to the beam path of the lens 42. However, because extruded materials are substantially uniform in cross-section (and thus define an extrusion axis), the exact placement or orientation of the sample part 48 (or parts) within the semicircular recesses 58 does not matter as long as the extrusion axis of each part 48 lies in parallel with the beam path of the lens 42. This is because any object, having a uniform cross-section, that is cradled in the semicircular recesses 58 of the fixture plates 52, 53 in parallel to the beam path of the lens 42 will, by definition, lie in the object field of the lens 42. This is also the property that permits the fixture plates 52, 53 to be filled with a plurality of extruded sample parts 48 for simultaneous imaging.

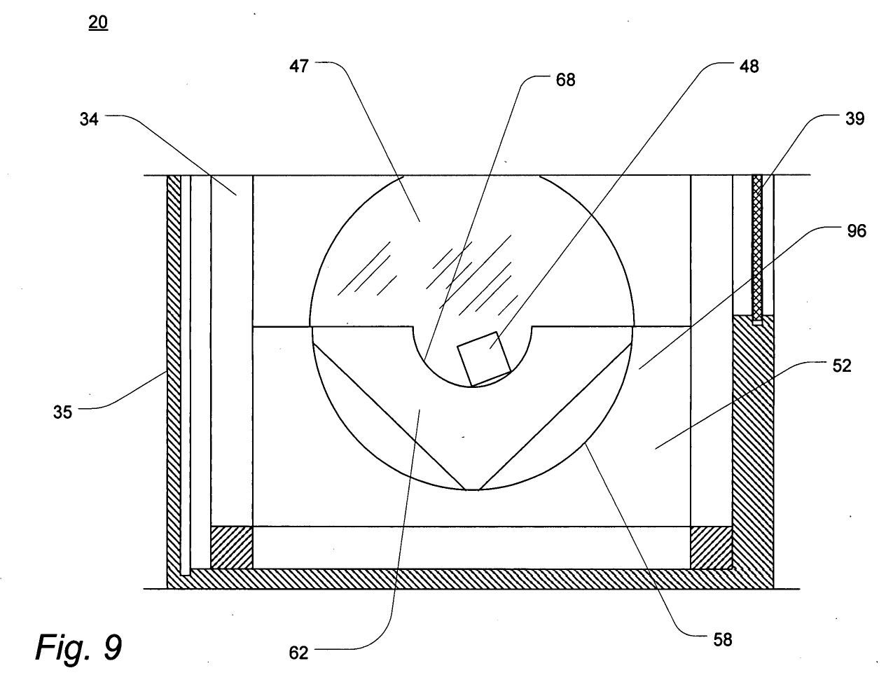

FIG. 9 is a partial left side cross-sectional view of the system 20 of FIG. 6, taken along line 8-8, illustrating an alternative fixture assembly 96 arrangement. This arrangement utilizes the same fixture plates 52, 53 as the arrangement shown in FIG. 8, but further includes a pair of fixture plate adapters 62. Each adapter 62 is adapted to fit in the semicircular recess 58 of a fixture plate 52, 53 and includes a smaller semicircular recess 68. When such an adapter 62 is disposed in the larger recess 58 of one of the fixture plates 52, 53, the smaller recess 68 is positioned such that samples 48 placed therein tend to lie near the center axis of the lens 42, thus enabling smaller samples 48 to be more or less centered in the object field of the lens 42, which is the portion of the lens likely to have the greatest accuracy. In commercial use, a particular system 20 may be supplied with a pair of fixture plates 52, 53 and a collection of fixture plate adapter sets 62, wherein each set of adapters 62 may include a recess 68 of a substantially different size. With such a collection of adapters 62, a user may select a set of adapters 62 based on the size or quantity of samples 48 to be tested at once. Each fixture plate adapter 62 may be fastened to the rest of the fixture assembly 96 using conventional means such as bolts, clamps, or the like.

With the system 20 activated, the sample part 48 or parts are illuminated by the light source 45, thus creating high visual contrast along the surfaces of the parts 48. The cross-sectional image is gathered by the lens 42 and transmitted to the camera 41, where it is captured in the CCD of the camera 41, thereby digitizing the image. Conventional optical measurement software may then be utilized to analyze the data thereby created by the CCD to determine the dimensions of the sample 48 or samples, whether these dimensions match the intended dimensions, and the like. Software suitable for use with the present invention is commercially available from DII International of High Point, N.C. and Ascona GmbH, Mecklenbeuren, Germany.

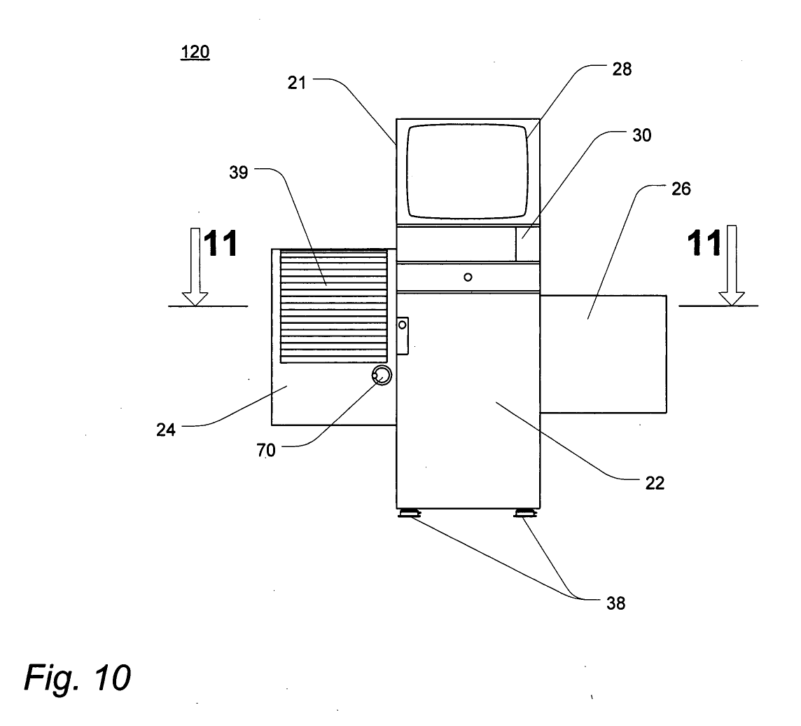

FIG. 10 is a front view of an optical measurement system 120 in accordance with a second preferred embodiment of the present invention. As with the first system 20, the second system 120 includes a cabinet 21 in which are housed a video monitor 28, a control panel 30 and a number of internal components. The cabinet 21 is preferably mounted on wheels or leveling feet 38 and includes a main compartment 22, an operational compartment 24, and a camera compartment 26, which are similar in arrangement and construction to those of the first system 20.

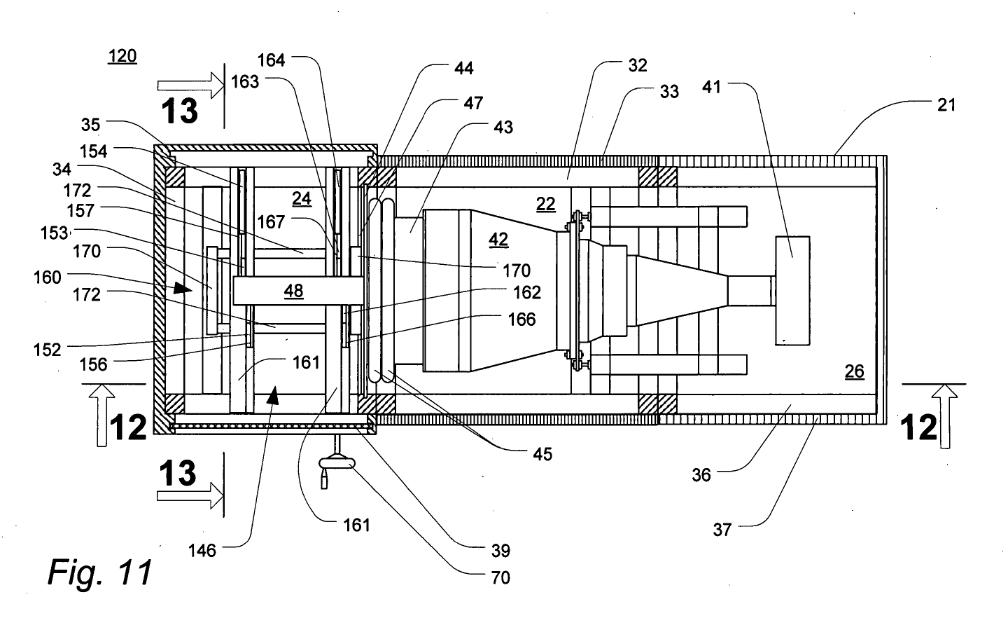

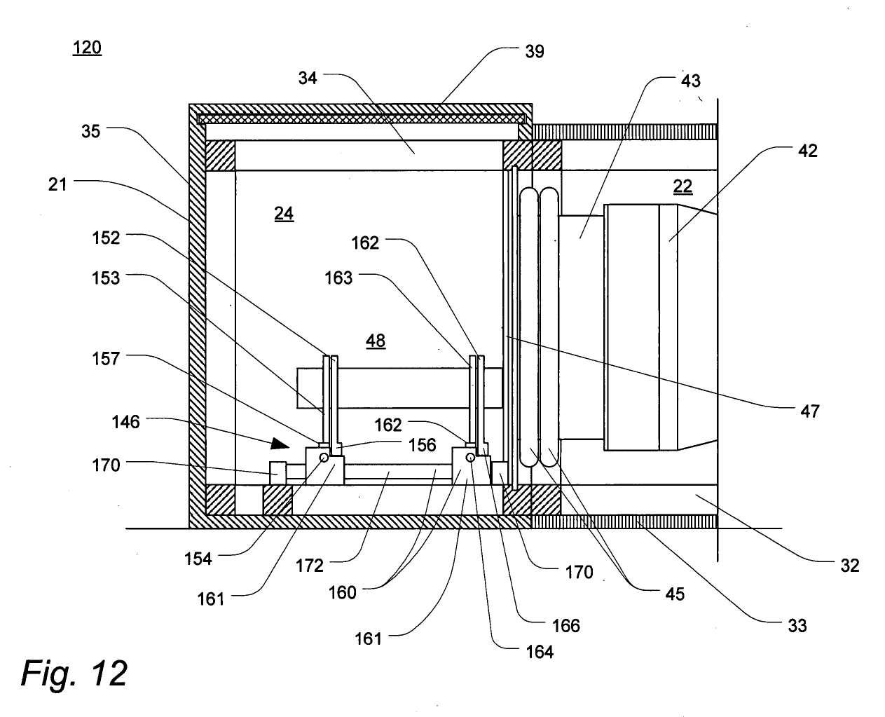

FIG. 11 is a top cross-sectional view of the system 120 of FIG. 10, taken along line 11-11, and FIG. 12 is a partial front cross-sectional view of the system 120 of FIG. 11, taken along line 12-12. As illustrated therein, the internal components of the system 120 include a camera 41, a telecentric lens 42, a diffusor 43, a pair of glass plates 44, 47, a light source 45, and a fixture assembly 146 for supporting one or more sample parts 48. The camera 41, telecentric lens 42, diffusor 43, glass plates 44, 47 and light source 45 may all be similar to those described above with regard to the first system 20. However, the fixture assembly 146 differs in a variety of respects from the fixture assembly 46 of the first preferred embodiment, as next described.

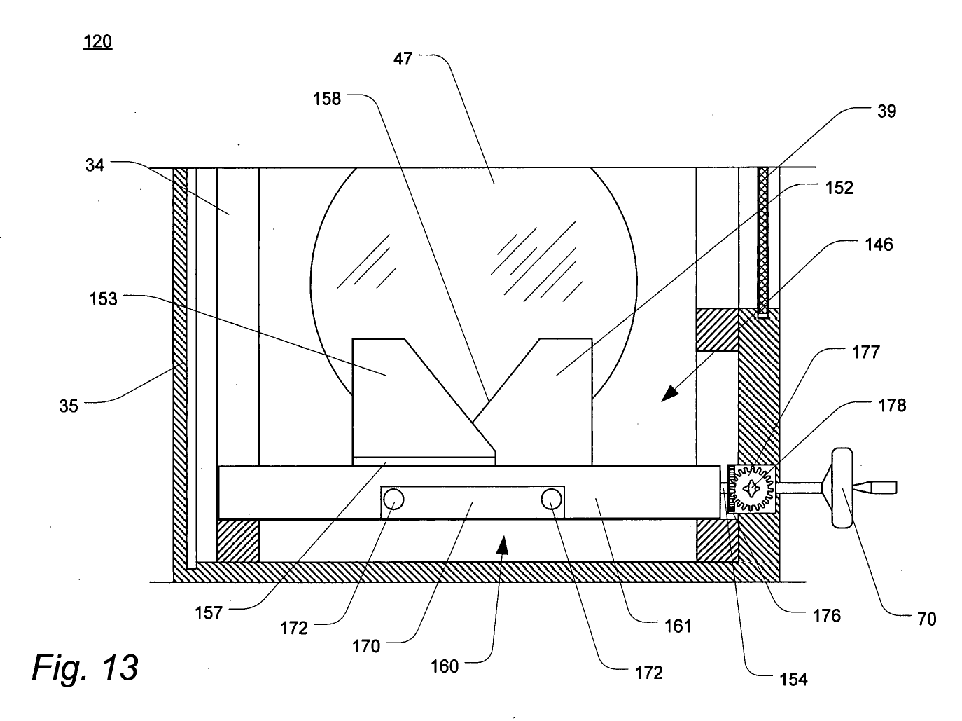

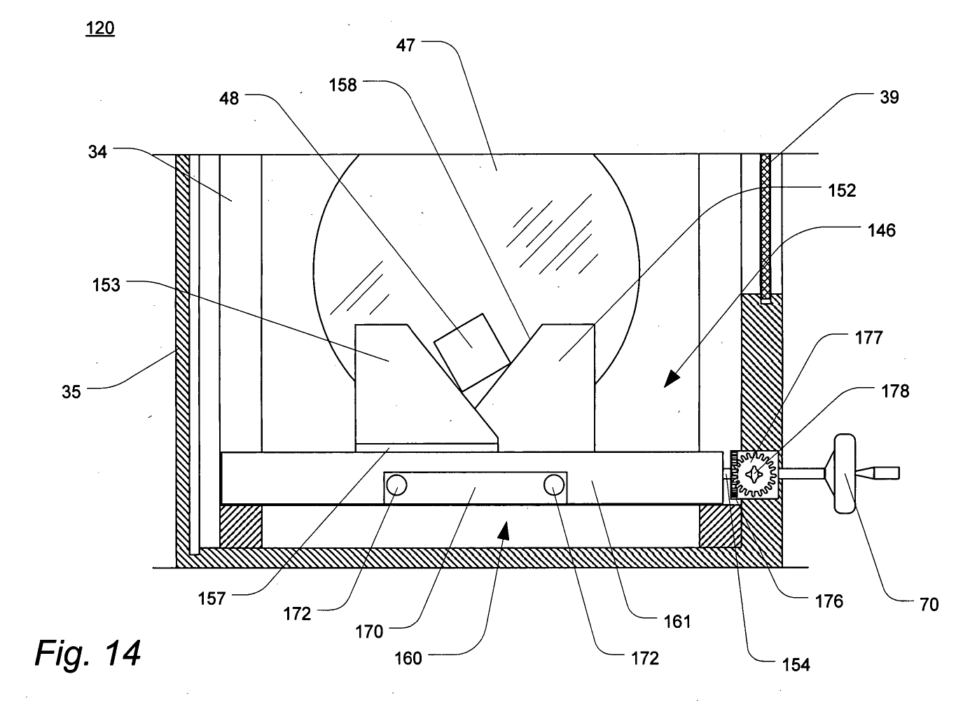

FIG. 13 is a partial left side cross-sectional view of the system 120 of FIG. 11, taken along line 13-13, and FIG. 14 is a partial left side cross-sectional view similar to that of FIG. 13, but illustrating the placement of a sample 48 therein. As collectively illustrated in FIGS. 11-13, the fixture assembly 146 includes four solid fixture plates 152, 153, 162, 163, each of which is trapezoidal in shape and supported by a respective plate mount 156, 157, 166, 167. The fixture plates 152, 153, 162, 163 are grouped in pairs, with the two plates in each pair (152, 153 and 162, 163) overlapping each other. In addition, the plates 152, 153, 162, 163 are oriented such that a V-shaped opening 158 is formed between each pair of plates 152, 153 and 162, 163, as shown in FIG. 13.

The plate mounts 156, 157, 166, 167 are slidably disposed in pairs upon rods 154, 164 such that one or more of the plate mounts 156, 157, 166, 167 may be moved horizontally, or at least generally laterally, in a direction perpendicular to the main axis of the lens 42. Thus, at least one of the plates in each pair of plates 152, 153 and 162, 163 (and preferably both plates in each pair) may be adjusted relative to the other plate in the same pair. Such relative movement between plates in the respective pairs 152, 153 and 162, 163 causes the V-shaped openings 158 formed therebetween to narrow or widen, depending on whether the plates are moved toward or away from each other. Movement may be effectuated manually or by a mechanical linkage to a hand-operated or automated control device. For example, as shown in FIGS. 13 and 14, a rotary handle 70 may be utilized to drive a system of gears 176, 177 linked to the respective rods 154, 164. The gears 176, 177 at the end of the first rod 154 may be linked to the gears (not shown) at the end of the second rod 164 by a keyed shaft 178. The rotation of the rods 154, 164 in turn imparts motion to the plate mounts 156, 157, 166, 167.

A mechanical linkage may also be utilized to link the movement of one plate mount in each pair of plate mounts 156, 157 and 166, 167 relative to the other such that movement of the first plate mount in each pair in one direction is mechanically accompanied by equal movement of the second plate mount of the pair in the opposite direction, thereby keeping each pair of plates 152, 153 and 162, 163 centered along the axis of the lens 42. This may accomplished, for example, using rods 154, 164 in combination with plate mounts which are correspondingly threaded, wherein the plate mount at one end of each rod 154, 164 is threaded in the opposite direction from the plate mount at the opposite end of each rod, or using any of a wide variety of other mechanisms. Once in their desired positions, the plates 152, 153 and 162, 163 may be held firmly in place by the general forces of friction, inertia and the like, thus providing a stable support for sample parts 48 during actual operation of the system 120. Optionally, however, a latch or lock mechanism (not shown) may be added to ensure that the plates 152, 153, 162, 163 are not accidentally moved from their desired location, or to otherwise provide additional reliability. The design of such a mechanism would be apparent to one of ordinary skill in the art.

Additional adjustability may be provided by supporting the plate mounts 156, 157, 166, 167 on an adjustable chassis 160. The chassis 160 includes a sliding support bar 161 for each pair of plate mounts and a pair of glide rods 172 supported by two end caps 170. Each sliding support bar 161 is slidably mounted on the glide rods 172 such that one or both pairs of plate mounts 156, 157 and 166, 167 may be moved longitudinally in a direction parallel to the axis or beam path of the lens 42. In addition, if the adjustable chassis 160 is utilized in conjunction with the system of gears 176, 177 described previously, then the drive gears 177 may be arranged to float along the keyed shaft 178, thus maintaining the relationship of the gear pairs 176, 177 regardless of the position of the drive gears 177 along the shaft 178. Movement may be effectuated manually or by a mechanical linkage to a hand-operated or automated control device (not shown). Once in their desired positions, the plate mounts 156, 157 and 166, 167 (or the sliding support bars 161) may then be locked in place so as to provide a stable support for sample parts 48 during actual operation of the system 120.

The size and shape of the plates 152, 153, 162, 163, and the positioning of their mounts 156, 157 and 166, 167, are preferably chosen such that the V-shaped openings 158 created between the respective pairs 152, 153 and 162, 163 are limited in size and location to an area no wider than the face of the lens 42, so that samples 48 placed therein will always be within the effective viewing area of the telecentric lens 42, as perhaps best seen in FIGS. 13 and 14. The end caps 170 supporting the chassis 160 are connected to, and supported by, the walls or framework of the operational compartment 24.

Use of the second system 120 is similar to that of the first system 20. The access door 39 of the operational compartment 24 is first opened, thus providing the user with access to the fixture assembly 146. One or more sample parts 48 may be placed in the V-shaped openings 158 in the fixture plates 152, 153, 162, 163 and arranged such that they lie in parallel with the axis or beam path of the lens 42. The shape and alignment of the fixture plates 152, 153, 162, 163 aids in this process because each sample part 48 has a natural tendency to settle into the same position in each of the fixture plates 152, 153, 162, 163, and the fixture plates 152, 153, 162, 163 are each positioned perpendicularly to the beam path of the lens 42. However, because extruded materials are uniform in cross-section, the exact placement or orientation of the sample part or parts 48 within the V-shaped openings 158 does not matter as long as each part 48 lies in parallel with the beam path of the lens 42. This is because any object, having a uniform cross-section, that is cradled in the V-shaped openings 158 of the fixture plates 152, 153, 162, 163 in parallel to the beam path of the lens 42 will, by definition, lie in the view of the lens 42. This is also the property that permits the fixture plates 152, 153, 162, 163 to be filled with a plurality of extruded sample parts 48 for simultaneous imaging.

With the system 120 activated, the sample part 48 or parts are illuminated by the light source 45, thus creating high visual contrast along the surfaces of the parts 48. This image is gathered by the lens 42 and transmitted to the camera 41, where it is captured in the CCD of the camera 41, thereby digitizing the image. Conventional optical measurement software may then be utilized to analyze the data thereby created by the CCD to determine the dimensions of the part 48 or parts, whether these dimensions match the intended dimensions, and the like. Software suitable for use with the present invention is commercially available from DII International of High Point, N.C. and Ascona GmbH, Mecklenbeuren, Germany.

Other variations of the various fixture assemblies 46, 96, 146 may likewise be envisioned. For example, in an alternative embodiment, a pair of fixture plates are provided, each with a V-shaped notch or opening formed along its upper edge. One of them may be moved longitudinally along a pair of rods, similar to those shown in the second embodiment. It will be apparent to one of ordinary skill in the art that a wide variety of additional arrangements of the various fixture assemblies 46, 96, 146 may also be utilized without departing from the scope of the present invention.

In the embodiments shown and described hereinabove, the light source 45 is a reflective light source, such as one or more circular bulbs, arranged adjacent the object end of the lens 42 so as to cast light on the extrusion sample(s) 48 that is captured by the camera 41 at the image end of the lens 42. In order to increase the contrast between the sample(s) 48 and the background in the image captured by the camera 41, the interior surfaces of the operational compartment 24 and the surfaces of the fixture assembly 46, 96, 146 are preferably painted black or otherwise blackened or darkened. This ensures that as much light as possible that is captured by the camera 41 is reflected by the sample(s) 48, rather than any other portion of the system 20. In images captured by the camera 41, the sample(s) 48 thus appear as a bright image against a dark background.

However, it will be apparent that in an alternative embodiment, not illustrated herein, the light source 45 may be a background light source against which the darker image of the sample(s) may be superimposed. For example, the light source 45 may be a “light wall” arranged at the end of the operational compartment 24 opposite the lens 42 in a manner apparent to those of ordinary skill in the art. Because of the absence of any reflective light source (such as the circular bulbs described previously), the end of the extrusion sample(s) 48 nearest the lens 42 remains dark, while the wall seen by the lens 42 in the background behind the sample(s) 48 is brightly lit. Thus, in contradistinction to the illustrated embodiments, the sample(s) 48 thus appear as a dark image against a bright background. The choice of which lighting system to use may be dependent upon the material from which the extrusion samples 48 are produced, and particularly its reflective nature.

Based on the foregoing information, it is readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to its preferred embodiment, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof. Although specific terms are employed herein, they are used in a generic and descriptive sense only and not for the purpose of limitation.

1. A method of analyzing an extrusion sample, the method comprising:
arranging the sample in a generally horizontal orientation in the object field of a telecentric lens;
capturing, via a camera positioned to receive images from the image field of the telecentric lens, an image of the cross-section of the sample via the telecentric lens; and
analyzing the sample image.

2. The method of claim 1, wherein the extrusion sample defines an extrusion axis and the telecentric lens defines a central axis, and wherein arranging the sample includes positioning the sample such that its extrusion axis is parallel to the central axis.

3. The method of claim 2, wherein arranging the sample includes supporting the side of the sample, from below.

4. The method of claim 3, wherein arranging the sample includes arranging a plurality of samples in a generally horizontal orientation in the object field of a telecentric lens, and wherein capturing an image includes capturing an image that includes all of the cross-sections of all of the plurality of samples.

5. The method of claim 2, wherein capturing includes capturing a digital image via a digital camera.

6. The method of claim 2, wherein capturing includes capturing a digital image via a linear scan camera.

7. The method of claim 2, further comprising:
converting the image captured via the camera to a digital image.

8. The method of claim 2, wherein analyzing includes analyzing, via software, the sample image.

9. The method of claim 2, further comprising:
separating the extrusion sample from the telecentric lens by a transparent partition assembly.

10. The method of claim 9, wherein arranging includes arranging the extrusion sample such that when the sample image is captured, the sample is spaced apart from the transparent partition assembly in a non-contact arrangement.

11. A system for analyzing an extrusion sample, comprising:
a telecentric lens;
a fixture assembly for supporting an extrusion sample in a generally horizontal orientation in the image field of the telecentric lens; and
a camera for capturing images of the cross-section of the sample via the telecentric lens while the sample is supported in the fixture assembly.

12. The system of claim 11, wherein the camera is a digital camera.

13. The system of claim 11, wherein the camera is a linear scan camera.

14. The system of claim 11, further comprising a light source.

15. The system of claim 14, wherein the light source is a reflective light source for casting light on the extrusion sample that is reflected from the sample to the telecentric lens.

16. The system of claim 15, wherein the fixture assembly is dark-colored to increase optical contrast between the extrusion sample and the fixture assembly.

17. The system of claim 14, wherein the light source is a background light source arranged in the background on the opposite end of the extrusion sample from the telecentric lens to increase optical contrast between the extrusion sample and the background.

18. The system of claim 11, further comprising a cabinet that substantially encloses the fixture assembly and the telecentric lens.

19. The system of claim 18, wherein the cabinet further substantially encloses the camera.

20. The system of claim 18, wherein the cabinet includes a first compartment, and wherein the fixture assembly is disposed in the first compartment.

21. A method of analyzing an extrusion sample, the method comprising:
providing an optical lens, defining a central axis;
arranging a fixture assembly, having at least one support that defines a recess for supporting at least a portion of the extrusion sample in alignment with the central axis of the lens, in front of the lens;
positioning the extrusion sample in the recess; and
capturing an image of the cross-section of the sample while the extrusion sample is positioned in the recess.

22. The method of claim 21, wherein capturing includes capturing a digital image of the cross-section of the sample.

23. The method of claim 22, wherein arranging a fixture assembly includes arranging a fixture assembly having at least one support that includes at least a pair of support structures that together define the recess, the method further comprising:
adjusting the position of at least one of the support structures to change the size of the recess.

24. The method of claim 21, wherein arranging a fixture assembly includes arranging a fixture assembly having at least two supports in front of the lens, the method further comprising:
moving at least one of the supports in a direction generally parallel to the central axis to adjust the distance between the at least two supports.

25. The method of claim 21, wherein positioning the sample in the recess includes positioning a plurality of samples in the recess, and wherein capturing an image includes capturing an image that includes all of the cross-sections of all of the plurality of samples.

26. The method of claim 21, wherein positioning the sample in the recess includes cradling the sample in the recess.

27. A system for analyzing an extrusion sample, comprising:
a lens;
a fixture assembly for supporting an extrusion sample in the image field of the lens, the fixture assembly including at least two fixture supports for supporting opposite ends of the extrusion sample; and
a digital camera for capturing digital images of the cross-section of the sample via the lens.

28. The system of claim 27, wherein the lens defines a central axis, and wherein the fixture assembly supports the extrusion sample in generally parallel alignment with the central axis of the lens.

29. The system of claim 28, wherein at least one of the fixture supports is a unitary support structure that defines a recess whose size and shape are arranged to position the extrusion sample in the image field of the lens.

30. The system of claim 29, wherein the image field of the lens is circular, wherein the at least one of the fixture supports is a fixture plate, and wherein the recess is generally semicircular.

31. The system of claim 29, further comprising an adapter, defining a recess of a size different than that of the recess in the unitary support structure, that may mounted to the fixture support by a user.

32. The system of claim 28, wherein at least one of the fixture supports includes first and second support structures that are adjustable relative to each other, wherein the first and second support structures jointly define a recess, and wherein the size of the recess may be changed by adjusting the disposition of the first support structure relative to the second support structure, thereby positioning the extrusion sample in the image field of the lens.

33. The system of claim 32, wherein the first and second support structures are fixture plates that jointly define a V-shaped recess, and wherein the size of the “V” may be changed by adjusting the disposition of the first support structure relative to the second support structure.

34. The system of claim 32, wherein the at least one fixture support is a first fixture support, wherein at least a second of the fixture supports includes third and fourth support structures that are adjustable relative to each other, wherein the third and fourth support structures jointly define a recess, and wherein the size of the recess may be changed by adjusting the disposition of the third support structure relative to the fourth support structure, thereby positioning the extrusion sample in the image field of the lens, the fixture assembly further including a linkage for controlling movement of the third support structure relative to the fourth support structure in conjunction with the control of movement of the first support structure relative to the second support structure.

35. The system of claim 34, wherein the fixture assembly further includes a user control device, connected to the linkage, that is adapted to provide simultaneous control of the adjustment of both the first and second support structures and the third and fourth support structures.

36. The system of claim 28, wherein at least one of the fixture supports may be moved in a direction generally parallel to the central axis to adjust the distance between the at least two fixture supports.

37. A system for analyzing an extrusion sample, comprising:
a cabinet having at least a first compartment and a second compartment arranged in a generally horizontal row;
an optical lens disposed at least partially in the first compartment; and
a camera disposed in the cabinet and arranged to receive images of an object placed in the second compartment via the optical lens.

38. The system of claim 37, wherein the cabinet further includes at least a third compartment, wherein the third compartment is arranged in the generally horizontal row such that the first compartment is interposed between the second and third compartments, and wherein the camera is disposed in the third compartment.

39. The system of claim 37, wherein the second compartment is defined by an enclosure.

40. The system of claim 39, wherein the enclosure defining the second compartment includes a door for accessing the compartment.

41. The system of claim 40, wherein the door is a roll top door.

42. The system of claim 37, wherein at least one transparent partition is interposed between the first and second compartments.

43. The system of claim 42, wherein the at least one transparent partition includes two glass partitions, one of which is arranged to be easily replaceable by an operator.

44. The system of claim 37, wherein a fixture assembly is disposed within the second compartment for supporting the object placed therein.

45. The system of claim 44, wherein the fixture assembly is adjustable to permit the object placed therein to be moved into the field of view of the optical lens.

46. The system of claim 37, wherein the second compartment includes at least one wall disposed in the field of view of the optical lens such that when placed therein, the object is interposed between the at least one wall and the optical lens.

47. The system of claim 46, wherein the at least one wall is dark in color to improve contrast between the at least one wall and the object.

48. The system of claim 46, wherein the at least one wall includes an illumination source that backlights the object.

49. The system of claim 37, further comprising a light source arranged to cast light on the extrusion sample that is reflected from the sample to the optical lens.

50. The system of claim 37, further comprising a video monitor interfaced with the camera and carried by the cabinet.

51. A method of analyzing an extrusion sample, the method comprising:
providing a cabinet having at least a first compartment and a second compartment arranged in a generally horizontal row;
positioning an optical lens at least partially in the first compartment;
positioning a camera adjacent the optical lens;
arranging the camera to receive images of objects that are placed in the second compartment via the optical lens;
placing an extrusion sample in the second compartment; and
capturing, in the camera, an image of the extrusion sample.

52. The method of claim 51, wherein providing a cabinet includes providing a cabinet having at least a third compartments arranged in the generally horizontal row such that the first compartment is interposed between the second and third compartments, and wherein positioning the camera includes positioning the camera in the third compartment.

53. The method of claim 51, wherein the second compartment includes a door that is adjustable at least between a closed position and an open position, the method further comprising:
before placing the extrusion sample in the second compartment, adjusting the door to the open position.

54. The method of claim 51, wherein the extrusion sample defines an extrusion axis, and wherein placing the extrusion sample in the second compartment includes aligning the extrusion axis of the extrusion sample horizontally with the optical lens.
